(19) United States
(12) Patent Application Publication
(10) Pub. No.: US 2015/0294578 A1
(43) Pub. Date: Oct. 15, 2015

(54) DISPLAY APPARATUS FOR STUDYING MASK AND METHOD FOR DISPLAYING STUDYING MASK

(71) Applicant: Sangbok GIL, Anyang Gyeonggi-do (KR)

(72) Inventor: Sangbok GIL, Anyang Gyeonggi-do (KR)

(21) Appl. No.: 14/439,889

(22) PCT Filed: Oct. 14, 2013
(86) PCT No.: PCT/KR2013/009149

§ 371 Date: Apr. 30, 2015

(30) Foreign Application Priority Data
Oct. 31, 2012 (KR) 10-2012-0121956

(51) Int. Cl. G09B 7/00; G09B 5/06; G06F 17/30; G09B 5/02; G06F 3/0481; G06F 17/24

(52) U.S. Cl. CPC G09B 7/00; G06F 3/0481; G06F 17/24; G06F 17/30312; G09B 5/02; G09B 5/06

(57) ABSTRACT

The present invention relates to a display apparatus for a studying mask and to a method for displaying a studying mask. The display apparatus for a studying mask according to one embodiment of the present invention, includes: a display unit displaying an electronic document; a user command input unit receiving a user command; and a control unit that displays a mask layer that covers at least one part of the electronic document that is displayed on the display unit according to a mask display command inputted by the user from the user command input unit, wherein the mask layer can be configured such that at least one transparency unit allows one part of the electronic document to be displayed without any change and at least one color unit allows one part of the electronic device to be dimly displayed or not displayed.

### TECHNICAL FIELD

The present invention generally relates to a learning mask display apparatus and a learning mask display method using the apparatus, which can improve learning effect when learning is undertaken using an electronic document.

### BACKGROUND ART

Recently, with the development of communication technology, learning methods have evolved from methods using paper books into methods using electronic documents due to the popularization of smart devices such as a computer, a smart phone, a Personal Digital Assistant (PDA), and a tablet Personal Computer (PC).

In this case, normal learning content such as for English and mathematics is generally composed of questions and answers. For example, in the case of an English vocabulary list, there are many cases where English words are indicated, and Korean meanings of the words are indicated besides or below the words. Reading comprehension content is generally configured in such a way that one paragraph is indicated and an interpretation thereof is subsequently provided. Further, when two persons have a conversation with each other in English, questions and answers successively appear. In this way, most learning content contains corresponding items that are alternately described.

Students may view questions and determine answers to the questions by themselves while hiding the answers. Thereafter, the students open an answer field and check whether their answers are correct. However, even if questions and answers are not alternately indicated, when content in which predetermined items and corresponding items are alternately described is viewed, the content is read in the above-described manner.

In particular, even when learning is undertaken using an electronic document, if questions and answers are alternately indicated, as described above, or if corresponding items are successively indicated, a user interface environment capable of improving learning effect is required.

### DISCLOSURE

### Technical Problem

Accordingly, the present invention has been made keeping in mind the above problems occurring in the prior art, and the present invention is intended to provide a learning mask display apparatus and method, which can effectively improve learning efficiency when learning is undertaken using electronic documents in which questions and answers are arranged or in which corresponding items are arranged.

### Technical Solution

For this, a learning mask display apparatus according to an embodiment of the present invention includes a display unit for displaying an electronic document, a user command input unit for receiving a command from a user, and a control unit for displaying a mask layer that hides at least a part of the electronic document displayed on the display unit in compliance with a user's mask display command received through the user command input unit, wherein the mask layer includes one or more transparent parts for allowing a part of the electronic document to be displayed without change, and one or more color parts for causing a part of the electronic document to be dimly displayed or to be hidden.

### Advantageous Effects

In accordance with the learning mask display apparatus and method of the present invention, a user who learns from an electronic document may effectively study using a method of masking a part or all of content, in which questions and answers are repeated or corresponding items are successively indicated, by executing the mask layer.

### DESCRIPTION OF DRAWINGS

FIG. 1 is a perspective view of a learning mask display apparatus according to an embodiment of the present invention;

FIG. 2 is a schematic configuration diagram showing a learning mask display apparatus according to an embodiment of the present invention;

FIG. 3 is a conceptual diagram showing a layer structure applied to a learning mask display apparatus according to an embodiment of the present invention;

FIG. 4 is a diagram showing a first embodiment of a mask layer applied to the present invention;

FIG. 5 is a diagram showing a second embodiment of a mask layer applied to the present invention;

FIG. 6 is a diagram showing a third embodiment of a mask layer applied to the present invention;

FIG. 7 is a diagram showing a fourth embodiment of a mask layer applied to the present invention.

FIG. 8 is a diagram showing a fifth embodiment of a mask layer applied to the present invention;

FIG. 9 is a diagram showing a sixth embodiment of a mask layer applied to the present invention;

FIG. 10 is a diagram showing a seventh embodiment of a mask layer applied to the present invention;

FIG. 11 is a diagram showing an eighth embodiment of a mask layer applied to the present invention;

FIG. 12 is a diagram showing a ninth embodiment of a mask layer applied to the present invention;

FIG. 13 is a diagram showing a tenth embodiment of a mask layer applied to the present invention; and

FIGS. 14 to 16 are diagrams illustrating a learning process using the mask layer according to the first embodiment of the present invention.

### BEST MODE

For this, a learning mask display apparatus according to an embodiment of the present invention includes a display unit for displaying an electronic document, a user command input unit for receiving a command from a user, and a control unit for displaying a mask layer that hides at least a part of the electronic document displayed on the display unit in compliance with a user's mask display command received through the user command input unit, wherein the mask layer includes one or more transparent parts for allowing a part of the electronic document to be displayed without change, and one or more color parts for causing a part of the electronic document to be dimly displayed or to be hidden.

The control unit may move a display position of the mask layer or moves a position of at least one of the transparent parts or the color parts in compliance with the user command.

The control unit may display the transparent parts and the color parts so that the transparent parts and the color parts are mutually reversed in compliance with the user command.

The control unit may change at least one of the color parts to a transparent part and display the transparent part, or change at least one of the transparent parts to a color part and displays the color part, in compliance with the user command.

The control unit may change a size of the mask layer or a size of at least one of the transparent parts or the color parts in compliance with the user command.

The mask layer may be displayed such that the transparent parts and the color parts are alternately formed in a vertical direction or a horizontal direction.

The mask layer may include a first mask layer in which the transparent parts and the color parts are alternately formed in a vertical direction, and a second mask layer connected to a left or right side of the first mask layer, and configured such that the transparent parts and the color parts are alternately formed in a vertical direction, wherein the transparent parts of the first mask layer and the color parts of the second mask layer are arranged adjacent to each other in a horizontal direction, and the color parts of the first mask layer and the transparent parts of the second mask layer are arranged adjacent to each other in a horizontal direction.

The control unit may additionally display an auxiliary mask layer including a color part on the display unit in compliance with the user command.

The user command input unit may include one or more of a display unit implemented as a touch panel, a mouse, a keyboard, and a button.

The learning mask display apparatus may further include a content input unit for receiving data including one or more of audio, a video, and the electronic document, a storage unit for storing data received via the content input unit, and an audio output unit for outputting audio data.

The control unit may configure the electronic document received via the content input unit in a form of a document layer, and display the document layer and the mask layer on the display unit.

The electronic document received via the content input unit may be edited such that data of a part to be displayed without change in correspondence with positions of the transparent parts and data of a part to be dimly displayed or to be hidden in correspondence with positions of the color parts correspond to the mask layer.

The control unit may search the storage unit for audio data for data located at positions corresponding to the transparent parts or the color parts in compliance with a preset user command, and output found audio data via the audio output unit.

Further, a learning mask display method for a display device according to an embodiment of the present invention includes 1) displaying an electronic document on a display unit, 2) receiving a mask display command from a user, and 3) displaying a mask layer that hides at least a part of the displayed electronic document in compliance with the mask display command, wherein the mask layer includes one or more transparent parts for allowing a part of the electronic document to be displayed without change, and one or more color parts for causing a part of the electronic document to be dimly displayed or to be hidden.

The learning mask display method may further include receiving a movement command from the user, and moving a display position of the mask layer or moving a position of at least one of the transparent parts or the color parts in compliance with the user's movement command.

The learning mask display method may further include receiving a reverse command from the user, and displaying the transparent parts and the color parts so that the transparent parts and the color parts are mutually reversed in compliance with the reverse command.

The learning mask display method may further include receiving a change command from the user, and changing at least one of the color parts to a transparent part and displaying the transparent part, or changing at least one of the transparent parts to a color part and displaying the color part, in compliance with the change command.

The learning mask display method may further include receiving a size change command from the user, and changing a size of the mask layer or a size of at least one of the transparent parts or the color parts in compliance with the size change command.

3) may be configured such that the mask layer is displayed such that the transparent parts and the color parts are alternately formed in a vertical direction or a horizontal direction.

The learning mask display method may further include receiving an auxiliary mask display command from the user, and displaying an auxiliary mask layer including a color part in compliance with the auxiliary mask display command.

The learning mask display method may further include receiving data including one or more of audio, a video, and the electronic document, and storing the received data.

The learning mask display method may further include forming the received electronic document in a form of a document layer, and displaying the document layer.

The electronic document may be edited such that data of a part to be displayed without change in correspondence with positions of the transparent parts and data of a part to be dimly displayed or to be hidden in correspondence with positions of the color parts correspond to the mask layer.

Furthermore, a storage medium storing instructions for executing respective operations in the method may be provided.

### MODE FOR INVENTION

Hereinafter, preferred embodiments of the present invention will be described in detail with reference to the attached drawings.

The embodiments of the present invention are intended to more completely describe the present invention to those skilled in the art. The following embodiments may be modified in other various forms, and the scope of the present invention is not limited by the following embodiments. Those embodiments are rather intended to make the present disclosure more faithful and complete, and to completely convey the spirit of the invention to those skilled in the art.

The terms used in the present specification are merely used to describe specific embodiments and are not intended to limit the present invention. A singular expression may include a plural expression unless a description to the contrary is specifically pointed out in context. In the present specification, it should be understood that the terms such as “comprise” and/or “comprising” are merely intended to indicate that features, numbers, steps, operations, components, parts, or combinations thereof are present, and are not intended to exclude a possibility that one or more other features, numbers, steps, operations, components, parts, or combinations thereof will be present or added. As used in the present specification, the term “and/or” includes any one of or one or more combinations of listed items.

The terms such as “first” and “second” may be used to describe various components, areas and/or regions, but it is apparent that those components, parts, areas, layers, and/or regions should not be limited by the terms. The terms do not mean a specific sequence, an upper or lower class, or superiority or inferiority, and are merely used to distinguish one component, area or region from other components, areas or regions. Therefore, a first component, area or region, which will be described later, may also designate a second component, area, or region without departing from the teaching of the invention.

Hereinafter, embodiments of the present invention will be described with reference to the attached drawings schematically showing embodiments of the present invention. In the drawings, shapes shown in the drawings may be expected to be modified according to the manufacturing technology and/or tolerance. Therefore, embodiments of the present invention should not be interpreted as being limited to specific shapes in areas shown in the present specification, and should include, for example, variation in shapes occurring in manufacturing.

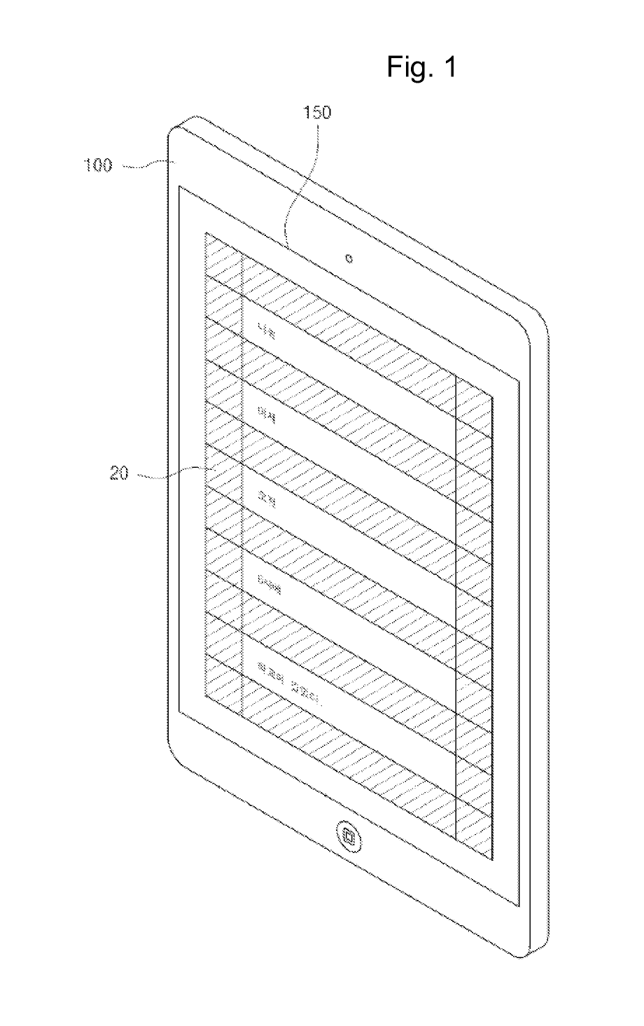

FIG. 1 is a perspective view of a learning mask display apparatus according to an embodiment of the present invention.

A learning mask display apparatus 100 may be either a fixed terminal that is used with the location thereof fixed in the home or office, such as a desk-top computer, or a mobile terminal such as that shown in FIG. 1. Examples of the mobile terminal may include a smart terminal such as an iPad, a mobile terminal such as a smart phone, a Personal Digital Assistant (PDA) terminal, etc.

Further, as the Operating System (OS) of the learning mask display apparatus 100, any type of OS, such as Windows OS, Macintosh (MAC) OS, mobile iPhone OS (iOS), or Android OS, may be used.

It can be seen in FIG. 1 that, on the display unit 150 of the learning mask display apparatus 100, a mask layer 20 is displayed, and that, in transparent parts of the mask layer, which will be described later, Korean words are displayed to appear without change, and English words corresponding to the Korean words are masked and are not displayed.

Below, a detailed configuration of the learning mask display apparatus 100 according to the present invention, the type of mask layer 20, and a learning method using the mask layer will be described in detail.

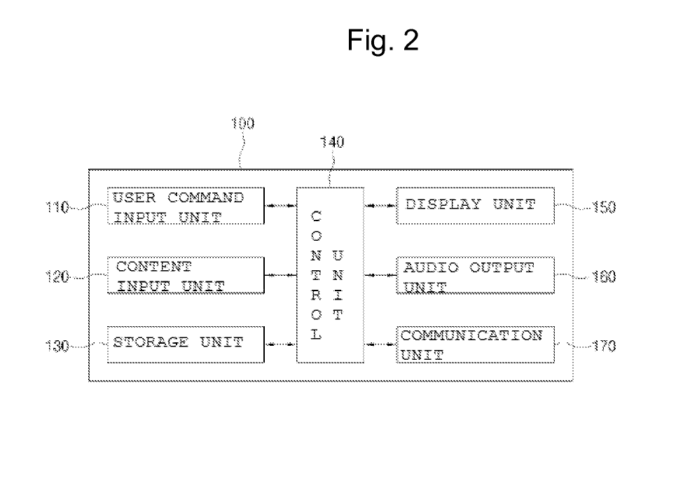

FIG. 2 is a schematic diagram showing a learning mask display apparatus according to an embodiment of the present invention.

Referring to FIG. 2, a learning mask display apparatus 100 according to an embodiment of the present invention includes a user command input unit 100, a content input unit 120, a storage unit 130, a control unit 140, a display unit 150, an audio output unit 160, and a communication unit 170.

The user command input unit 100 functions to receive various types of commands from a user. When the display unit 150, which will be described later, is formed on a capacitive touch panel, the touch panel may be used as the input unit 100. In addition, it is apparent that various types of input means, such as a separately provided button and a keyboard or a mouse connected to the learning mask display apparatus 100, may be configured.

The content input unit 120 functions to receive data such as text, Portable Document Format (PDF), a photograph, a video, and audio (voice), from the user via an application program installed in the learning mask display apparatus 100. As will be described later, the learning mask display apparatus 100 according to the present invention may not only display a mask layer 20 on a display screen for separate content received through the communication unit 170, which will be described later, and an electronic document displayed by other application programs the display screen, but also display the mask layer 20 while loading content received via the content input unit 120 through an exclusive application program, which is basically installed, and displaying the content.

The storage unit 130 may store a file such as a text file, a PDF file, a music file, a video file, or a photograph file, which is received via the content input unit 120, or various types of set values of the learning mask display apparatus 100. Further, data related to various types of mask layers 20 is also stored.

The display unit 150 functions to display various types of operations of the learning mask display apparatus 100, and may be formed using a panel such as a Liquid Crystal Display (LCD) panel or a Light Emitting Diode (LED) panel, or may be formed using a capacitive or resistive touch panel to function both as a display unit and as the above-described user command input unit 110.

The audio output unit 160 is implemented using a speaker or the like and functions to allow a user to input a separate command in response to an action displayed on the display unit 150 or to play audio or music when a preset condition is satisfied.

The communication unit 170, which is implemented as an antenna or the like, is connected to a mobile communication network, such as a Code Division Multiple Access (CDMA) network, to function to perform data communication, or is connected to the Internet via a wired or wireless Local Area Network (LAN) to function to transmit and receive data.

The control unit 140 functions to control the overall operation of the learning mask display apparatus 100 in such a way as to receive data from the above components and process the data. For example, the control unit 140 receives various types of user commands received via the user command input unit 110 and executes operations corresponding to the commands. That is, when the user inputs a mask display command while learning an electronic document via the display unit 150, the control unit 140 displays the mask layer 20 on the display unit 150. Details thereof will be described later. In this case, an electronic document may correspond to each of a text file, a PDF file, and a photograph file, or a document formed by a combination of those files.

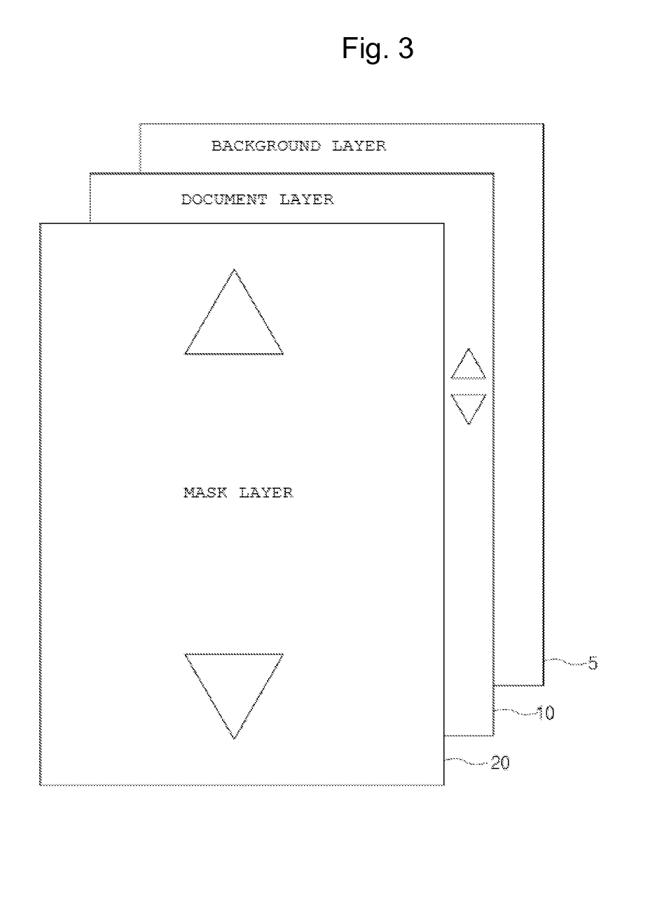

FIG. 3 is a conceptual diagram showing a layer structure applied to the learning mask display apparatus according to an embodiment of the present invention.

Referring to FIG. 3, the learning mask display apparatus 100 according to the present invention may exploit a scheme in which a background layer 5, a document layer 10, and a mask layer 20 are sequentially stacked and displayed.

The background layer 5 basically denotes the background screen of the learning mask display apparatus 100, and the background screen may be either a background screen on which no other applications are running or a screen on which other application programs are running.

The document layer 10 basically denotes a layer formed using input data when a basic application program according to the present invention runs and electronic document data such as text, PDF, drawing, or photograph data is input from the user.

The mask layer 20 is a layer stacked on the top of the document layer 10 and functions to mask at least a part of an electronic document. A detailed structure and operation of the mask layer 20 will be described later.

FIG. 3 illustrates a case where an existing application program is basically running, and the user separately inputs electronic document data via the basic application program, that is, where a document layer 10 is separately formed. However, if an application program is running and the user does not input separate electronic document data, the mask layer 20 is directly displayed on the background layer 5.

That is, when the user does not separately input electronic document data, the basic application program is displayed in such a way that a screen currently displayed on the learning mask display apparatus 100 becomes the background layer 5, and the mask layer 20 is displayed on the background layer 5.

In this case, there may be a case where, when the user learns from an electronic document retrieved over the Internet while viewing the electronic document, a basic application program runs and only the mask layer 20 is displayed as an uppermost layer.

Further, the layer sequence of FIG. 3 illustrates only an embodiment, and any scheme for stacking layers in another sequence may also be used as long as the same results can be yielded.

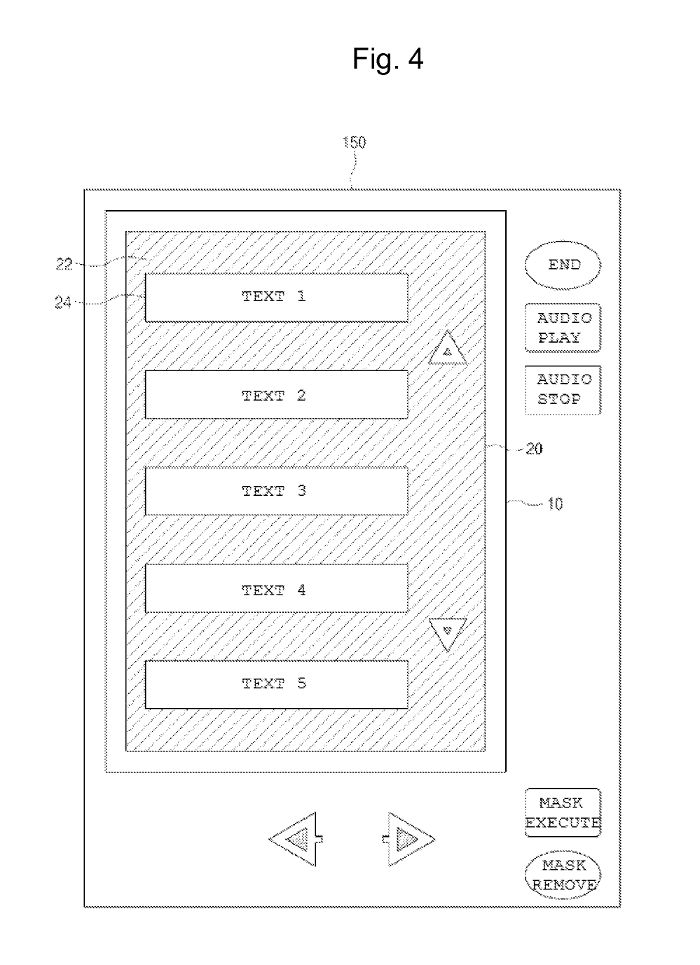

Hereinafter, for convenience of description, detailed operations of a case where a user loads prepared data through a basic application program and displays the data as the document layer 10 will be described by way of example in detail with reference to FIGS. 4 to 16.

FIG. 4 is a diagram showing a first embodiment of a mask layer applied to the present invention.

FIG. 4 illustrates a state in which only the display unit 150 of the learning mask display apparatus 100 according to the present invention is shown for convenience of illustration. The drawing shows a case where the user runs a basic application program, wherein a mask layer 20 is displayed on a document layer 10, and icons required to receive user inputs are formed to the right of and below the document layer 10.

More specifically, on the right side of the document layer 10, icons such as ‘end’, ‘audio play’, and ‘audio stop’ are displayed, and in a portion below the right side of the document layer, icons such as ‘mask execute’ and ‘mask remove’ are displayed. In a portion below the document layer, left/right arrow icons for ‘page turning’ or ‘content change’ are formed.

The screen of FIG. 4 indicates a case where a user clicks on the icon ‘mask execute’ and the mask layer 20 is displayed. Of course, although not shown in FIG. 4, an icon for data loading or the like may be additionally formed to receive an electronic document to be displayed on the document layer 10.

The mask layer 20 of FIG. 4 may include transparent parts 24 for displaying electronic document data displayed on the document layer 10 without change, and color parts 22 for causing electronic document data to be dimly displayed or to be hidden.

The color parts 22 are generally formed to have a color such as gray or black, but it is apparent that the color parts 22 may also be formed to have a chromatic color such as red or yellow. Here, the color parts 22 of the mask layer 20 may be separately implemented as transparent layers or opaque layers, and this separation may be performed by adjusting the depth of a color. Of course, it is also possible to form the color parts as opaque layers so that other layers are not always viewed regardless of the depth of a color.

In the present invention, as an embodiment of this configuration, a case where, when the color parts 22 are implemented in a gray or black color, they are used as opaque layers causing data of an electronic document to be hidden, and when the color parts 22 are implemented in a chromatic color such as red or yellow, they are used as transparent layers causing data of an electronic document to pass therethrough and to be reflected will be described by way of example.

In FIG. 4, up and down arrow icons are displayed in upper and lower portions of the right side of the mask layer 20, and indicate that, when the user touches and drags the mask layer 20, the position of the mask layer 20 may be moved in a vertical direction. More specifically, control such as the position movement or the like of the mask layer may be implemented in a wide variety of manners.

That is, when the user slowly drags the mask layer 20 while touching a part of the mask layer 20, the entire mask layer 20 may be moved in a drag direction.

Further, when the user touches the up arrow icon or the down arrow icon displayed on the right side of the mask layer 20, the color parts 22 and the transparent parts 24 of the mask layer 20 may be promptly and mutually reversed. In this case, mutual reverse may be performed such that the entire portions of the color parts 22 and the transparent parts 24 are mutually reversed or such that only upper and lower regions corresponding to the size of each transparent part 24, out of the regions of the color parts 22, may be mutually reversed.

That is, to explain this operation concretely, in FIG. 4, text 1 to text 5 that are currently displayed may be Korean words, and portions masked by the color parts 22 may include English words corresponding to Korean words. In this case, an English word is masked below the corresponding Korean text. In a state in which the region of each color part 22 is designated to be hidden in the form of a cell corresponding to the size of each transparent part 24 below the transparent part 24, when a reverse command is received, only the corresponding designated portion may be changed to the transparent part 24 and may be displayed. That is, upon explaining in easy terms, cell regions in which English and Korean words are displayed are alternately displayed as the transparent parts 24 and as the color parts 22.

By means of this operation, a user who learns using an electronic document may view Korean or English at one time and may view the corresponding Korean or English words by reversing such masking, thus improving learning efficiency.

Further, when the user takes an action of touching a portion using his or her two fingers and then spreading his or her fingers, the entire size of the mask layer 20 may be magnified, whereas when the user takes an action of closing his or her fingers, the entire size of the mask layer 20 may be reduced.

Unlike this, only the horizontal or vertical length of the mask layer may be adjusted using a touch and drag action, and the sizes of the regions of the transparent parts 24 or the color parts 22 may be individually adjusted via such length adjustment.

When the ‘audio play’ icon is clicked, pre-stored audio data is played. When the ‘audio stop’ icon is clicked, the play of the corresponding audio data is stopped. When the ‘mask execute’ icon is clicked, the mask layer 20 is displayed on the display unit 150. When the ‘mask remove’ icon is clicked, the displayed mask layer 20 is removed.

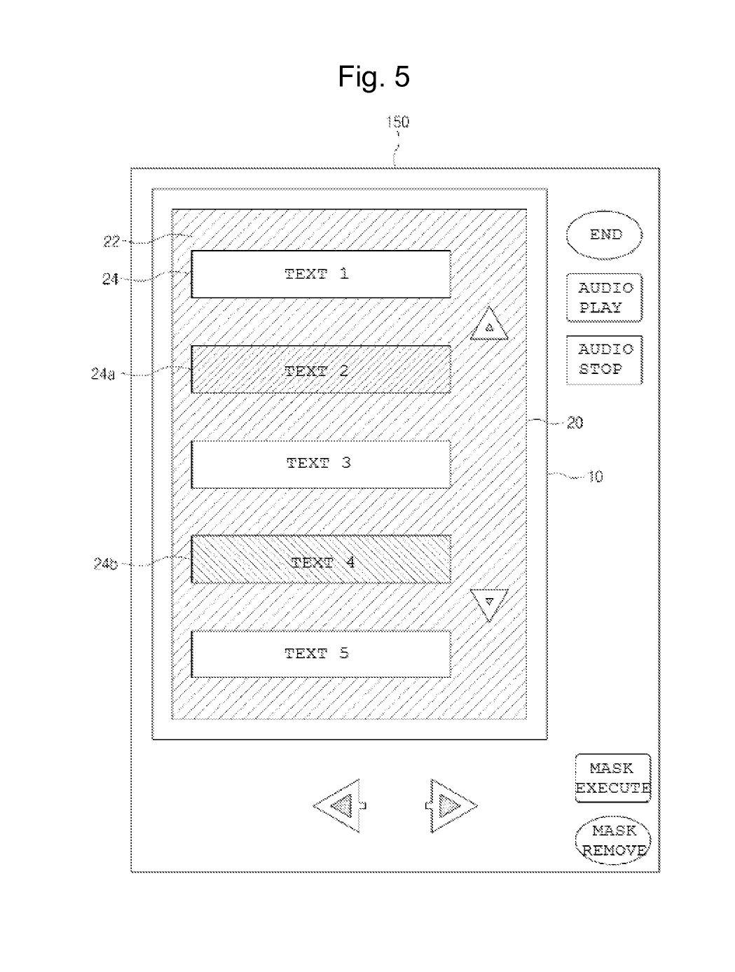

FIG. 5 is a diagram showing a second embodiment of a mask layer applied to the present invention.

The configuration of FIG. 5 is similar to that of FIG. 4 except that color parts 22 are additionally displayed in some regions corresponding to transparent parts 24.

For example, regions corresponding to other transparent parts 24 are displayed without having any color transmission layer, but a yellow color part 22 may be additionally displayed in a transparent part 24a, and ‘text 2’ may be displayed while passing through the color part 22. A red color part 22 may be additionally displayed in a transparent part 24b and ‘text 4’ may be displayed while passing through the color part 22.

The remaining components are identical to those of FIG. 4, and thus a detailed description thereof will be omitted.

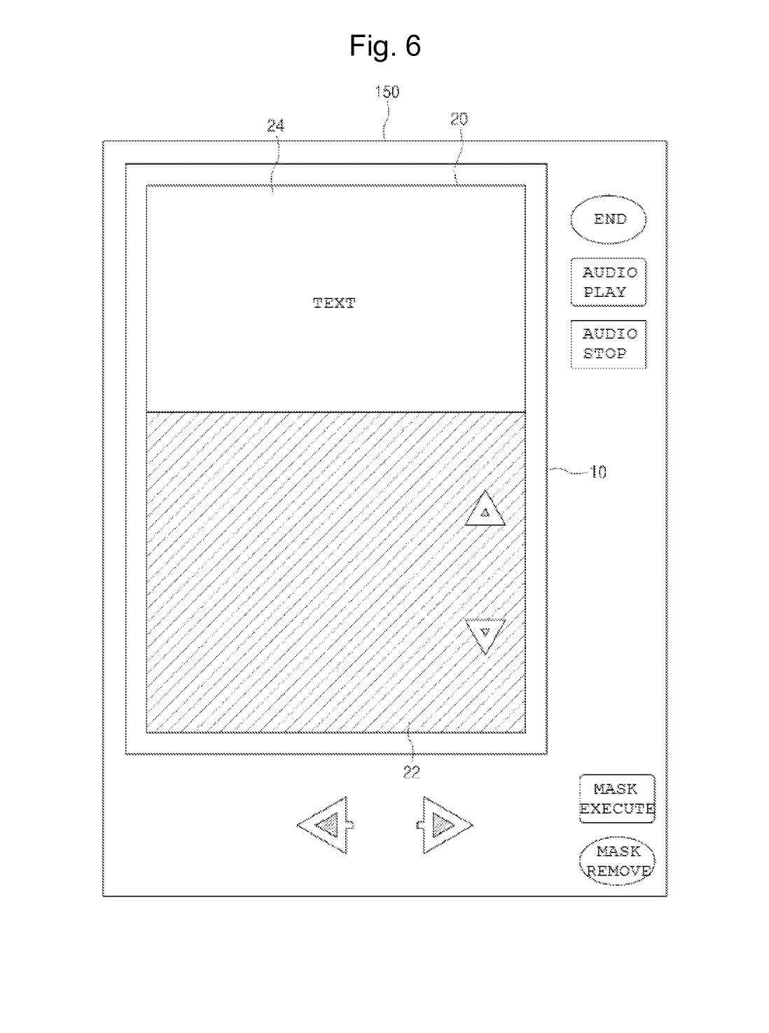

FIG. 6 is a diagram showing a third embodiment of a mask layer applied to the present invention.

FIG. 6 illustrates a case where a mask layer 20 is composed of only two parts, that is, a transparent part 24 and a color part 22. In the region of the transparent part 24, text is displayed, and in a region below the transparent part 24, text is masked with the color part 22. The mask layer 20 having this shape is useful when learning content in which an English reading paragraph and interpretation thereof are successively indicated is used.

Of course, it is possible to control the mask layer 20 of FIG. 6 in such a way as to move the entire mask layer 20, as shown in FIG. 4, to move only the color part 22 or the transparent part 24, to change the size of the entire mask layer 20, or to change the size of the color part 22 or the transparent part 24.

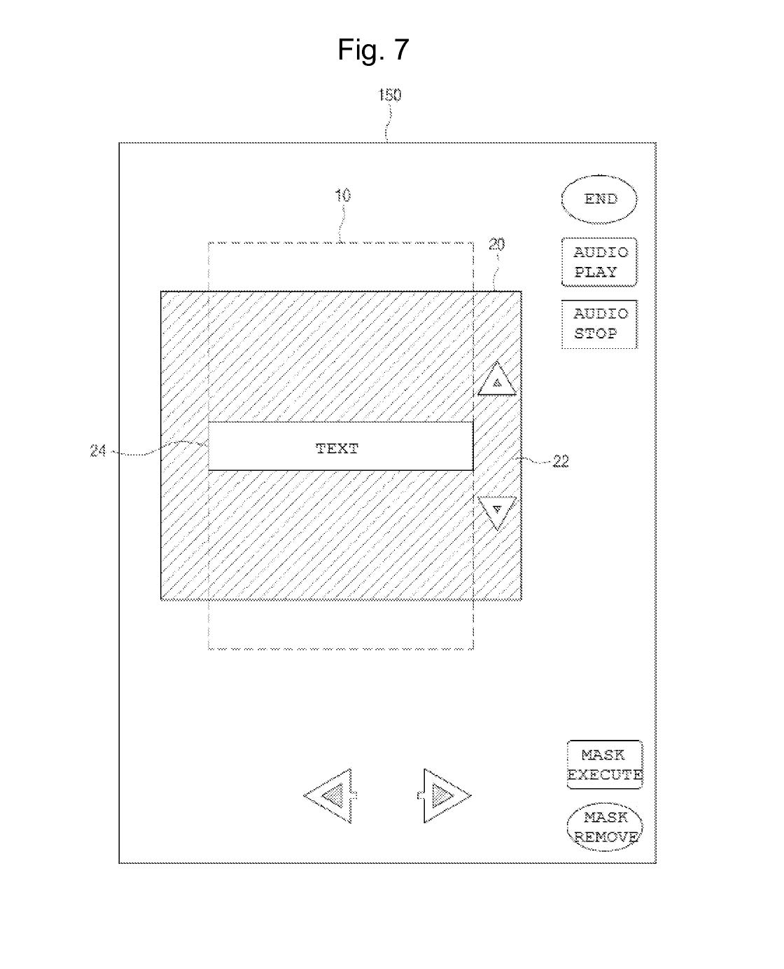

FIG. 7 is a diagram showing a fourth embodiment of a mask layer applied to the present invention.

FIG. 7 illustrates a case where only a transparent part 24 corresponding to one cell is formed at the center of a mask layer 20 to view text only in a partial region of a document layer 10. Only a desired region may be displayed while a user is vertically moving the mask layer 20 by dragging the mask layer 20.

Similarly, it is possible to control the mask layer 20 in such a way as to change the size of the mask layer 20, move the position of the mask layer 20, or reverse the mask layer 20, as shown in FIG. 4.

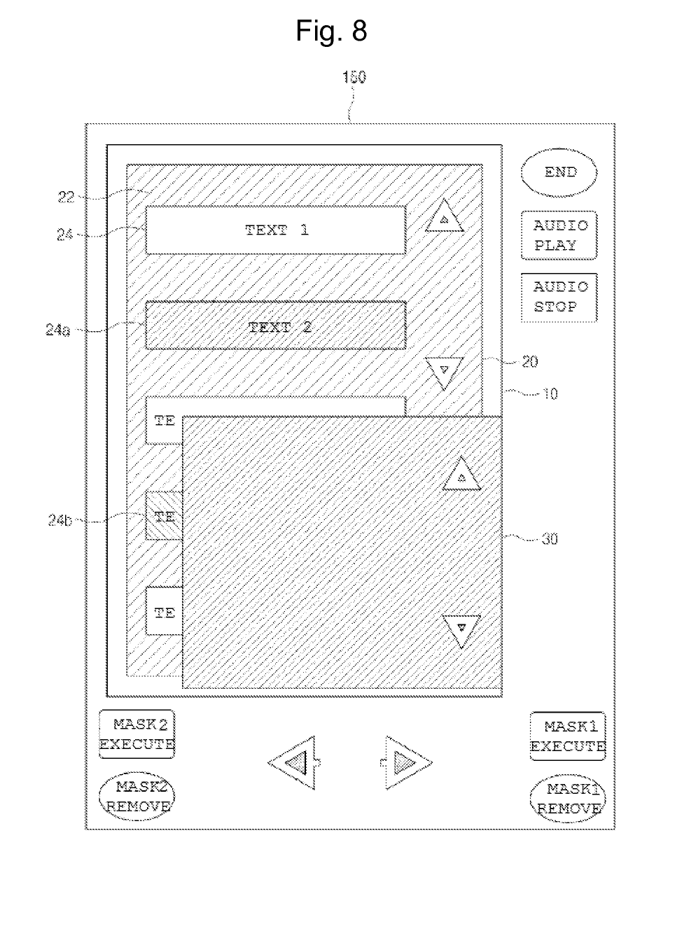

FIG. 8 is a diagram showing a fifth embodiment of a mask layer applied to the present invention.

FIG. 8 illustrates a case where an auxiliary mask layer 30 is additionally displayed in the second embodiment of FIG. 5. For this, ‘mask 1 execute’ icon and ‘mask 2 execute’ icon are provided on a display unit 150, so that the auxiliary mask layer 30 is additionally executed while a mask layer 20 is executed as a first mask to learn an electronic document, thus enabling learning to be more efficiently performed.

In this case, the entirety of the auxiliary mask layer 30 is implemented as an opaque color part 22. Of course, although not shown in the drawing, one or more transparent parts 24 may be formed in the auxiliary mask layer 30.

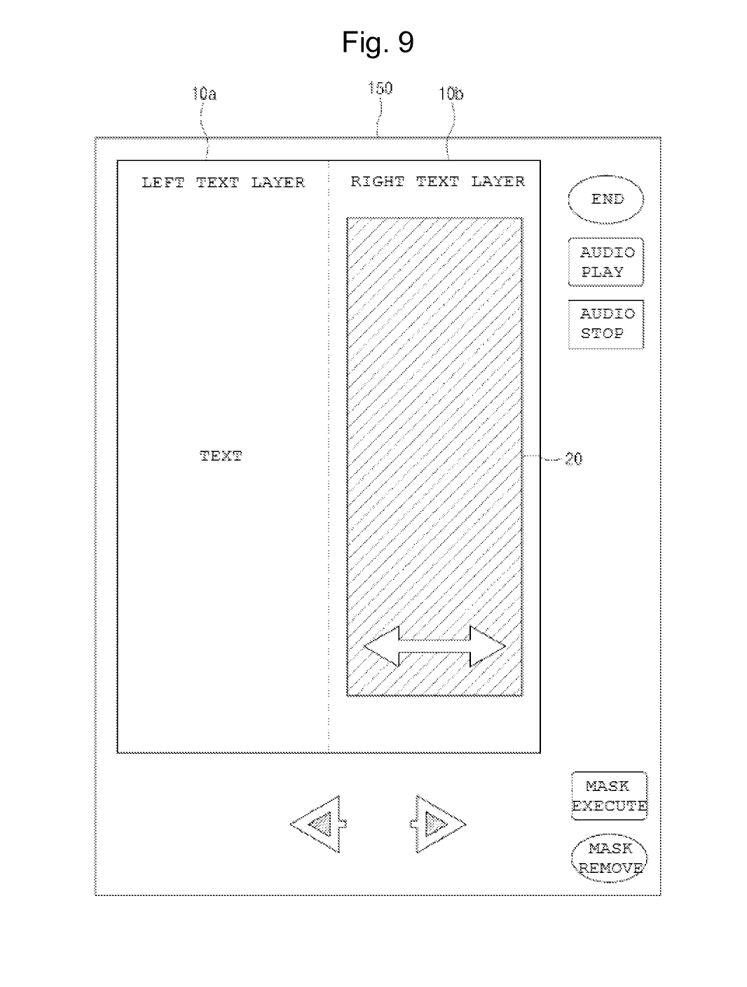

FIG. 9 is a diagram showing a sixth embodiment of a mask layer applied to the present invention.

FIG. 9 illustrates a case where two layers on which an electronic document is to be displayed are formed. That is, a document layer 10a located on the left and a document layer 10b located on the right are displayed side by side, and a user may separately input pieces of data of different documents to the document layers 10a and 10b.

For example, the user may input Korean language data to the left side and input English data corresponding to the content of the Korean data to the right side. Further, text or PDF data may be input to the left side and photograph or drawing data may be input to the right side. Of course, in the above example, the positions of left and right data may be exchanged.

Here, a mask layer 20 implemented as only a color part 22 is displayed, thus allowing the user to learn while viewing only a part of Korean or English data.

Here, as in the above case, when text or PDF data is input to the left side, text may be displayed, and a photograph or a drawing corresponding to the text may be masked and hidden on the right side, and thus learning may be effectively performed while masking is released. For example, when an English word “Clock” is displayed on the left side, in a state in which “drawing indicating a clock shape” is masked and hidden, the user may learn by comparing the English word with a meaning associated with the word while releasing masking.

Further, control such as reverse, movement and size change may be performed in a manner similar to that of FIG. 4.

For example, the user may learn while horizontally moving the mask layer 20 to the left or right, changing the size of the mask layer, or moving the position of the mask layer 20 by using a drag action.

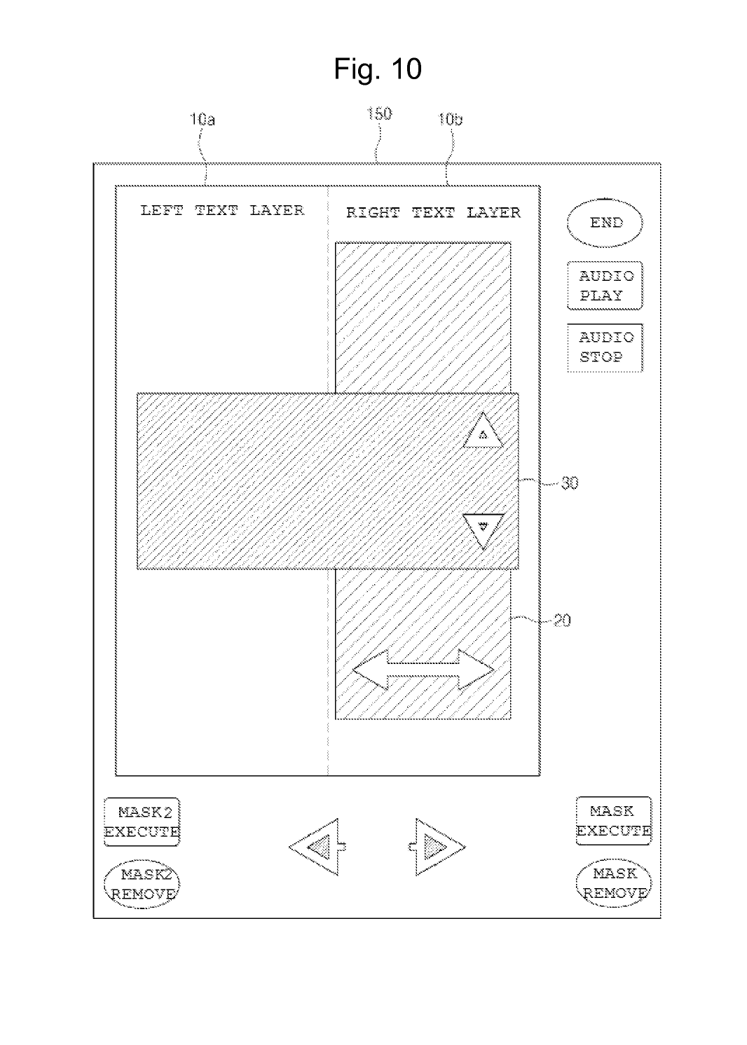

FIG. 10 is a diagram showing a seventh embodiment of a mask layer applied to the present invention.

The configuration of FIG. 10 is identical to that of the sixth embodiment of FIG. 9 except that an auxiliary mask layer 30 is additionally displayed in the sixth embodiment. Different text items are input to the left and right sides, so that a user may learn while horizontally moving a mask layer 20 to the left or right, and may more effectively learn while vertically moving an auxiliary mask layer 30 that is formed to be horizontally long to cover both left and right text regions.

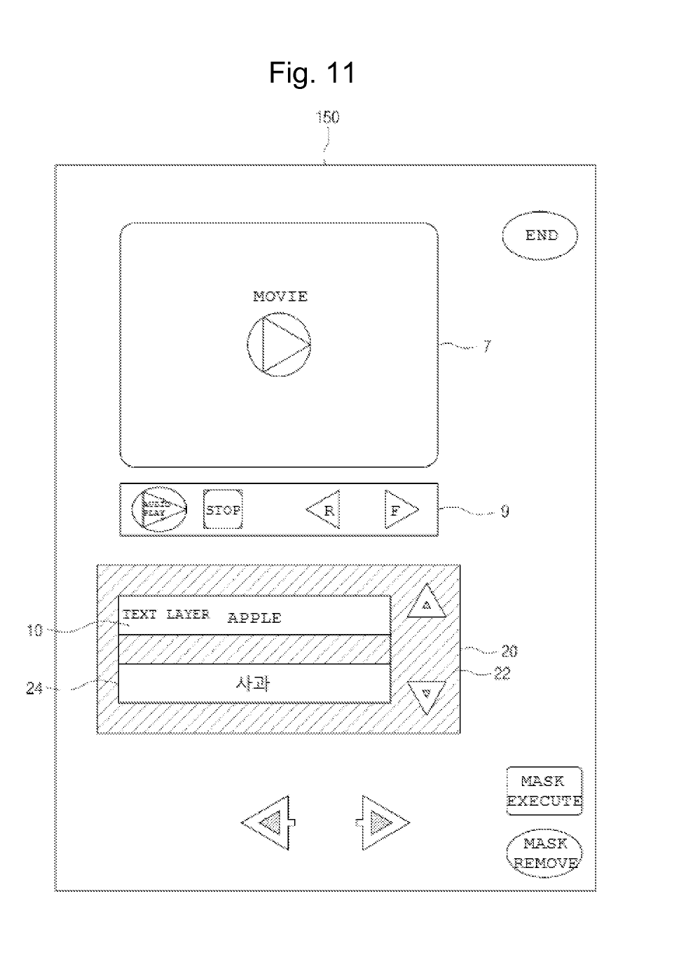

FIG. 11 is a diagram showing an eighth embodiment of a mask layer applied to the present invention.

Referring to FIG. 11, an image output region 7 is configured, a control region 9 is configured, and both a document layer 10 and a mask layer 20 are arranged below the control region 9.

A user may play a video such as a movie in the image output region 7, and English or Korean data related to the played video may be displayed in the region of the document layer 10. In this case, the user may effectively learn using the mask layer 20 in a manner similar to the above embodiments in such a way as to play audio, stop a video, or vertically scroll an electronic document (text layer) by controlling the control region 9.

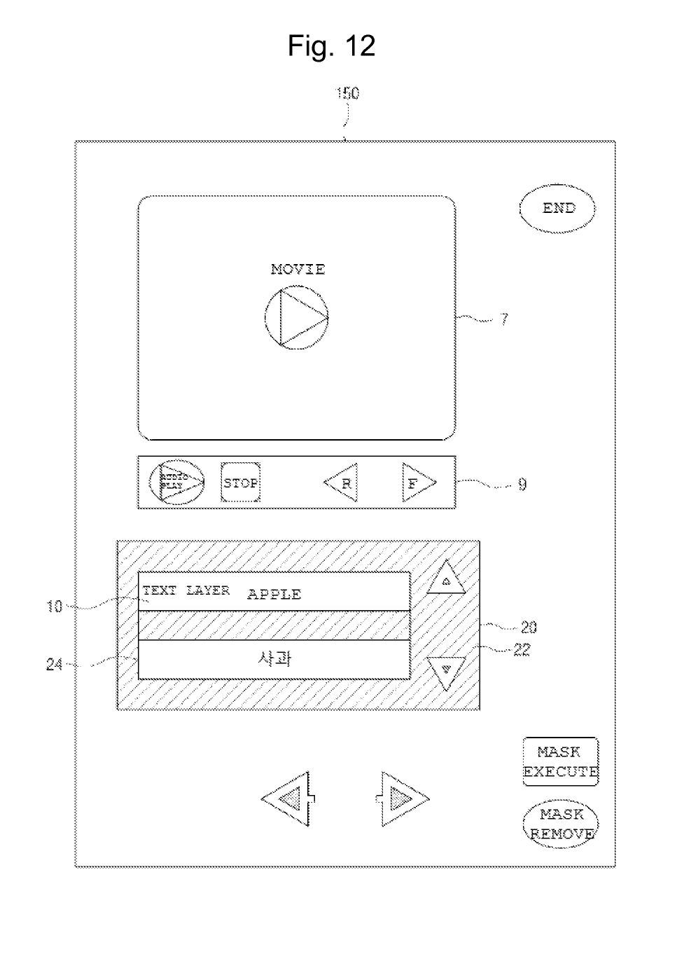

FIG. 12 is a diagram showing a ninth embodiment of a mask layer applied to the present invention.

A mask layer 20 of FIG. 12 is composed of color parts 22 and transparent parts 24, which are alternately arranged in a vertical direction. The color parts 22 and the transparent parts 24, which are arranged on the left and right sides, are adjacent to each other.

Here, pieces of data are arranged in the document layer 10 to correspond to the positions of the transparent parts 24 and the color parts 22 of the mask layer 20. As shown in FIG. 12, English words are arranged on the left side and Korean words corresponding thereto are arranged on the right side.

When words are arranged in this way, English words are alternately displayed on the left side, and Korean words are alternately displayed on the right side. A user who performs learning via this arrangement may effectively learn using a method of associating Korean words corresponding to English words respectively arranged on the left side, and associating English words corresponding to Korean words arranged on the right side.

For example, as shown in FIG. 12, the user may view an English word “Apple” arranged on the left side and associate a Korean word ‘ [symbol] ’ hidden by the color part 22 on the right side, and may view a Korean word “ [symbol] ” arranged on the right side and associate an English word ‘book’ hidden by the color part 22 on the left side.

Control such as the position movement, reverse, and size change of the mask layer 20 may be performed in a manner similar to that of FIG. 4. In particular, such control may be implemented such that learning is performed by reversing regions of a left transparent part 24 and a right color part 22 in the same line, or by moving only a region of the color part 22 to the left and right.

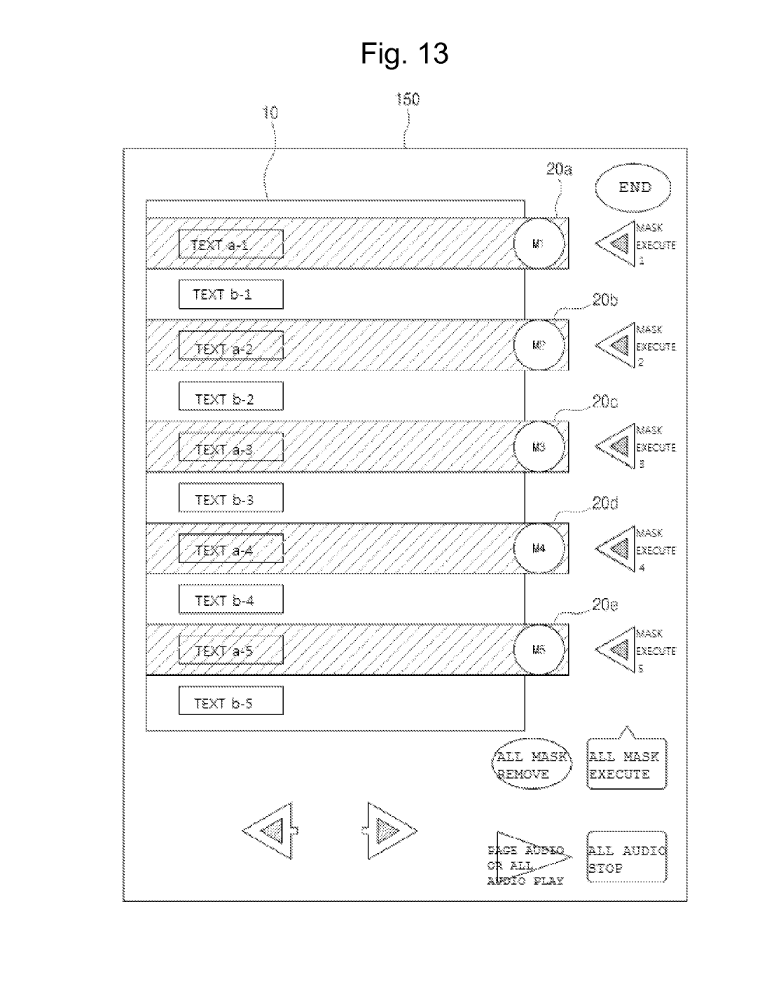

FIG. 13 is a diagram showing a tenth embodiment of a mask layer applied to the present invention.

FIG. 13 illustrates a mask layer 20 in which only English is hidden by mask layers 20a to 20e in a document layer 10 in which Korean and English are alternately arranged. In the embodiment of FIG. 3, when a right end portion of one of the mask layers 20a to 20e is touched, an executed mask is removed and text appears, and in addition, audio corresponding to text arranged below the mask is individually played.

That is, FIG. 13 relates to an embodiment in which respective masks are separately executed, and audio of text below the masks is played while the executed masks are being separately removed.

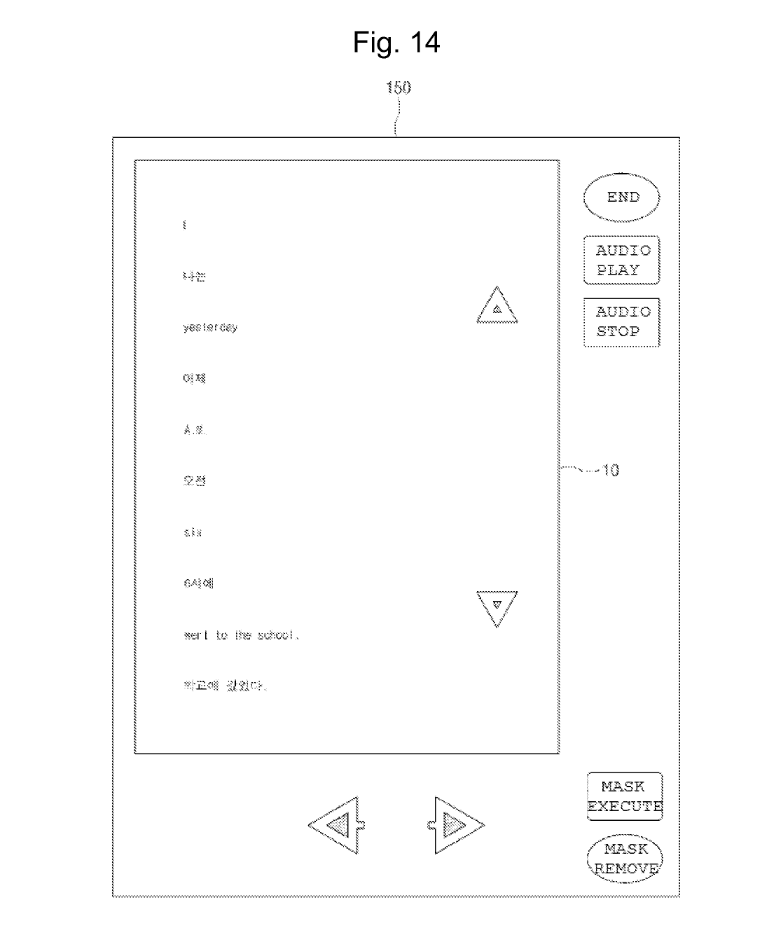

FIGS. 14 to 16 are diagrams illustrating a learning process using the mask layer according to the first embodiment of the present invention.

FIG. 14 illustrates a state in which a document layer 10 is loaded and displayed on a display unit 150. An electronic document displayed on the document layer 10 is a text file, and English words and Korean words corresponding thereto are displayed in respective cells.

On the document layer 10, up and down arrow icons are indicated. When a user touches and vertically drags the document layer 10, data of the document layer 10 that is the text file is displayed while vertically moving upwards or downwards. That is, when the amount of text file data exceeds one page, data in a next page is not viewed in a lower portion, but is viewed if the document layer 10 is dragged upwards.

Of course, it is possible to configure one text file using only data displayed in one page, configure text files of separate pages using next data, and display the text files by turning over individual pages.

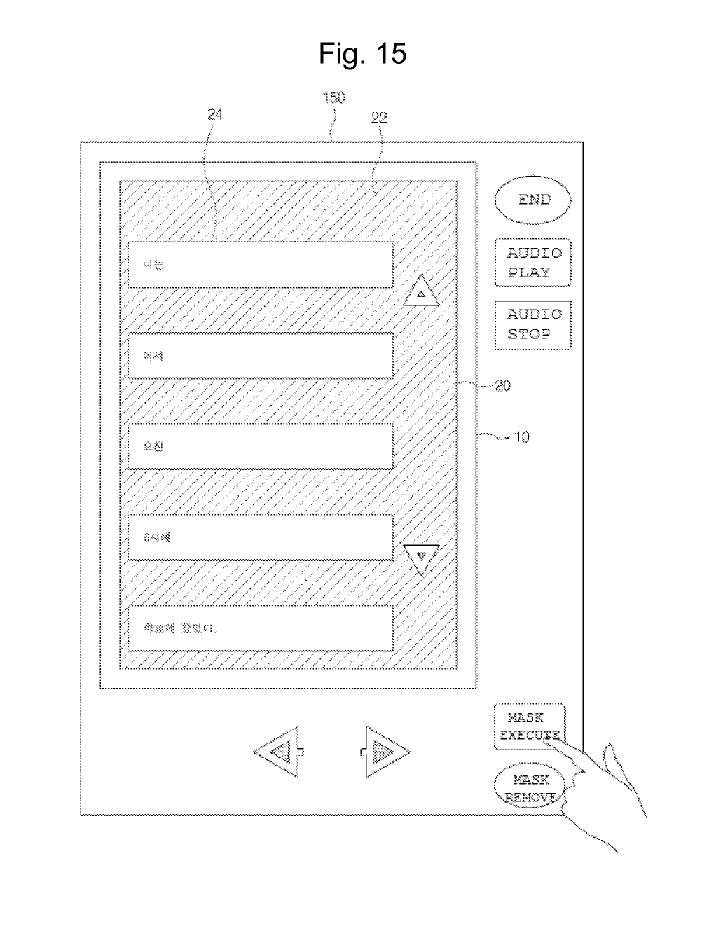

In this state, when the user touches a ‘mask execute’ icon, as shown in FIG. 15, the mask layer 20 is displayed on the document layer 10. The mask layer 20 has a shape according to the first embodiment, and has a structure in which color parts 22 and transparent parts 24 are alternately arranged.

It can be seen in FIG. 15 that English words are masked with the color parts 22 of the mask layer 20 and are not viewed, and only Korean words are displayed without change in correspondence with the positions of the transparent parts 24.

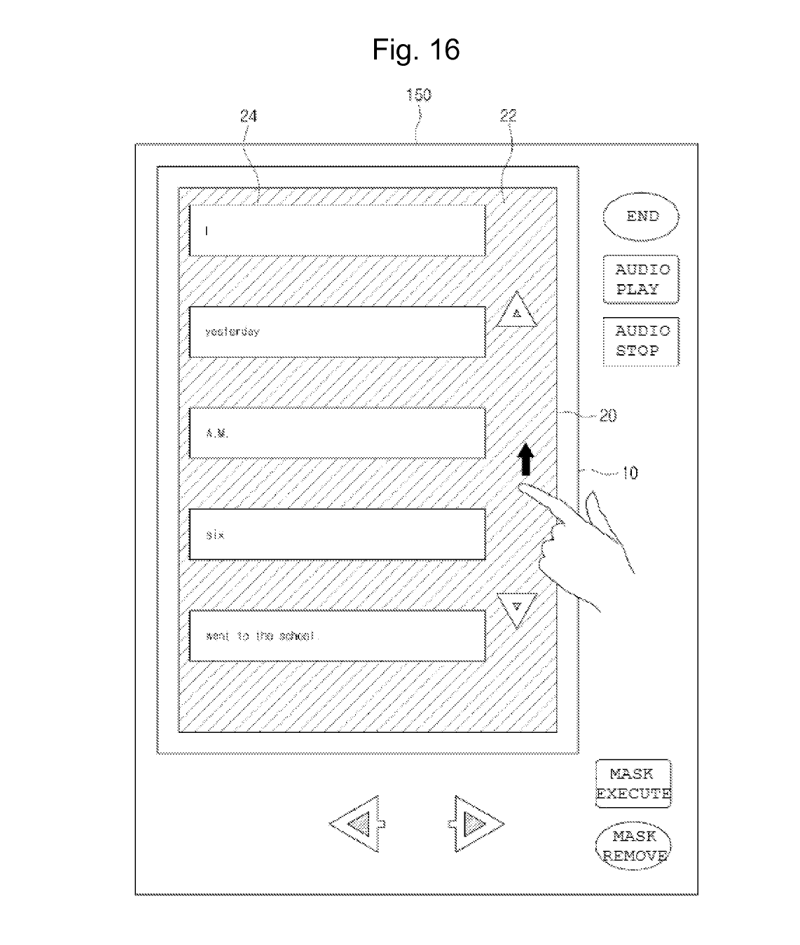

Here, when the user performs an action of touching the mask layer 20 and quickly moving the mask layer 20 upwards, as shown in FIG. 16, that is, a flick action, a masked English word is located and displayed in the corresponding transparent part 24 while the mask layer 20 is moved upwards by one cell. Further, as described above, the mask layer 20 may be configured to quickly move upwards or downwards by one cell via even an action of touching an up or down arrow icon displayed in the right portion of the mask layer 20.

In this case, when electronic document data input by the user via the content input unit 120 may be text or PDF format data, wherein the positions of English or Korean text may be previously edited to correspond to the positions of the color parts 22 and the transparent parts 24 in conformity with the above-described mask types.

When an electronic document is a text file, the text file may be input via the content input unit 120 in such a way as to copy and paste the text file. In this case, all data may be inserted into a single page. Meanwhile, when an electronic document is a PDF file, only a single PDF page may be inserted into a single page, and the entire content may be formed and configured in different pages.

Further, the above-described editing may be performed by the user previously editing text data or PDF data in conformity with the masking type. However, when data is input without being edited, programming may be implemented such that an application automatically edits the data.

For example, respective sentences are distinguished from each other using periods or the like in the sentences, or sentence intervals are adjusted in conformity with the masking type. Alternatively, “characters corresponding to questions/answers” present in a sentence characters (e.g., ‘ [symbol] ’, ‘ [symbol] ’, ‘Q’, and ‘A’) may be automatically extracted, so that it is determined whether the corresponding sentence is a part corresponding to a question or a part corresponding to an answer, and the sentence may be automatically edited in conformity with the masking type.

Further, it is also possible to implement, instead of editing an electronic document in conformity with the masking type, a scheme for analyzing the masking type using the above method, generating in real time a mask layer having color parts and transparent parts at the positions corresponding to masking, and displaying the mask layer on the display unit.

In accordance with those various embodiments, a user who studies using an electronic document may more conveniently learn while freely executing a mask layer, and may double his or her learning effect.

Although the embodiments of the present invention have been described with reference to the drawings, the embodiments are merely intended to describe the present invention and are not intended to limit or restrict the details of the present invention. However, those skilled in the art may practice various modifications and equivalent embodiments from those embodiments. Therefore, technical scope of the present invention should be defined by the technical details of the accompanying claims.

1. A learning mask display apparatus, comprising:
a display unit for displaying an electronic document;
a user command input unit for receiving a command from a user; and
a control unit for displaying a mask layer that hides at least a part of the electronic document displayed on the display unit in compliance with a user's mask display command received through the user command input unit,
wherein the mask layer includes one or more transparent parts for allowing a part of the electronic document to be displayed without change, and one or more color parts for causing a part of the electronic document to be dimly displayed or to be hidden.

2. The learning mask display apparatus of claim 1, wherein the control unit moves display position of the mask layer or moves a position of at least one of the transparent parts or the color parts in compliance with the user command.

3. The learning mask display apparatus of claim 1, wherein the control unit displays the transparent parts and the color parts so that the transparent parts and the color parts are mutually reversed in compliance with the user command.

4. The learning mask display apparatus of claim 1, wherein the control unit changes at least one of the color parts to a transparent part and displays the transparent part, or change at least one of the transparent parts to a color part and displays the color part, in compliance with the user command.

5. The learning mask display apparatus of claim 1, wherein the control unit changes a size of the mask layer or a size of at least one of the transparent parts or the color parts in compliance with the user command.

6. The learning mask display apparatus of claim 1, wherein the mask layer is displayed such that the transparent parts and the color parts are alternately formed in a vertical direction or a horizontal direction.

7. The learning mask display apparatus of claim 6, wherein the mask layer comprises:
a first mask layer in which the transparent parts and the color parts are alternately formed in a vertical direction; and
a second mask layer connected to a left or right side of the first mask layer, and configured such that the transparent parts and the color parts are alternately formed in a vertical direction,
wherein the transparent parts of the first mask layer and the color parts of the second mask layer are arranged adjacent to each other in a horizontal direction, and the color parts of the first mask layer and the transparent parts of the second mask layer are arranged adjacent to each other in a horizontal direction.

8. The learning mask display apparatus of claim 1, wherein the control unit additionally displays an auxiliary mask layer including a color part on the display unit in compliance with the user command.

9. The learning mask display apparatus of claim 1, wherein the user command input unit comprises one or more of a display unit implemented as a touch panel, a mouse, a keyboard, and a button.

10. The learning mask display apparatus of claim 1, further comprising:
a content input unit for receiving data including one or more of audio, a video, and the electronic document;
a storage unit for storing data received via the content input unit; and
an audio output unit for outputting audio data.

11. The learning mask display apparatus of claim 10, wherein the control unit configures the electronic document received via the content input unit in a form of a document layer, and displays the document layer and the mask layer on the display unit.

12. The learning mask display apparatus of claim 10, wherein the electronic document received via the content input unit is edited such that data of a part to be displayed without change in correspondence with positions of the transparent parts and data of a part to be dimly displayed or to be hidden in correspondence with positions of the color parts correspond to the mask layer.

13. The learning mask display apparatus of claim 10, wherein the control unit searches the storage unit for audio data for data located at positions corresponding to the transparent parts or the color parts in compliance with a preset user command, and outputs found audio data via the audio output unit.

14. A learning mask display method for a display device, comprising:
1) displaying an electronic document on a display unit;
2) receiving a mask display command from a user; and
3) displaying a mask layer that hides at least a part of the displayed electronic document in compliance with the mask display command,
wherein the mask layer includes one or more transparent parts for allowing a part of the electronic document to be displayed without change, and one or more color parts for causing a part of the electronic document to be dimly displayed or to be hidden.

15. The learning mask display method of claim 14, further comprising:
receiving a movement command from the user; and
moving a display position of the mask layer or moving a position of at least one of the transparent parts or the color parts in compliance with the user's movement command.

16. The learning mask display method of claim 14, further comprising:
receiving a reverse command from the user; and
displaying the transparent parts and the color parts so that the transparent parts and the color parts are mutually reversed in compliance with the reverse command.

17. The learning mask display method of claim 14, further comprising:
receiving a change command from the user; and
changing at least one of the color parts to a transparent part and displaying the transparent part, or changing at least one of the transparent parts to a color part and displaying the color part, in compliance with the change command.

18. (canceled)

19. (canceled)

20. (canceled)

21. The learning mask display method of claim 14, further comprising:
receiving data including one or more of audio, a video, and the electronic document; and
storing the received data.

22. The learning mask display method of claim 21, further comprising;
forming the received electronic document in a form of a document layer; and
displaying the document layer.

23. The learning mask display method of claim 14, wherein the electronic document is edited such that data of a part to be displayed without change in correspondence with positions of the transparent parts and data of a part to be dimly displayed or to be hidden in correspondence with positions of the color parts correspond to the mask layer.

24. (canceled)
